(19) United States
(12) Patent Application Publication
(10) Pub. No.: US 2025/0001635 A1
(43) Pub. Date: Jan. 2, 2025

(54) OPTICAL SHEET MANUFACTURING METHOD AND OPTICAL SHEET MANUFACTURING APPARATUS

(71) Applicant: FUJIFILM Corporation, Tokyo (JP)

(72) Inventor: Takehiko NAKAYAMA, Kanagawa (JP)

(73) Assignee: FUJIFILM Corporation, Tokyo (JP)

(21) Appl. No.: 18/882,359

(22) Filed: Sep. 11, 2024

Related U.S. Application Data
(63) Continuation of application No. PCT/JP2023/011561, filed on Mar. 23, 2023.

(30) Foreign Application Priority Data
Mar. 29, 2022 (JP) 2022-052858

(51) Int. Cl. B26D 5/00; B26F 1/44; G02B 5/18; G06T 7/60

(52) U.S. Cl. CPC B26D 5/007; B26F 1/44; G02B 5/1833; G06T 7/60; G06T 2207/30108

(57) ABSTRACT

An object of the present invention is to provide an optical sheet manufacturing method and an optical sheet manufacturing apparatus capable of cutting out an optical sheet having a concentric circular pattern from an optical sheet base material, on which the optical sheet is formed, with high accuracy, low cost, and simplicity. The object is achieved by detecting a center of the concentric circular pattern of the optical sheet and determining a cutout position of the optical sheet in the optical sheet base material in accordance with a detection result of the center.

### CROSS-REFERENCE TO RELATED APPLICATIONS

This application is a Continuation of PCT International Application No. PCT/JP2023/011561 filed on Mar. 23, 2023, which claims priority under 35 U.S.C. § 119(a) to Japanese Patent Application No. 2022-052858 filed on Mar. 29, 2022. The above applications are hereby expressly incorporated by reference, in their entirety, into the present application.

### BACKGROUND OF THE INVENTION

### 1. Field of the Invention

The present invention relates to an optical sheet manufacturing method of cutting out an optical sheet having a concentric circular pattern from an optical sheet base material on which the optical sheet is formed and an optical sheet manufacturing apparatus that performs the optical sheet manufacturing method.

### 2. Description of the Related Art

In the manufacturing of a sheet-like optical element such as an optical sheet or an optical film, each of the optical sheets is cut out from an optical sheet base material on which a plurality of optical sheets are formed. In the following description, the “optical sheet base material” is also simply referred to as a “base material”.

In the manufacturing of the optical sheet, it is necessary to cut out the optical sheet from the base material with high accuracy. For this purpose, a reference mark corresponding to each optical sheet is provided on the base material, and the cutout position of the optical sheet on the base material is determined by detecting the reference mark.

For example, JP6695670B describes a polarizing plate manufacturing method including the following methods. In the manufacturing of the polarizing plate by cutting out the polarizing plate from a base material, an elongated polarizing plate (base material) having non-polarizing portions disposed at predetermined intervals in an elongated direction and a width direction is cut out sequentially from one side to the other side in the width direction for each predetermined feeding pitch in the elongated direction. In addition, before the elongated polarizing plate is cut, in a state where the elongated polarizing plate is stopped, a position of the non-polarizing portion is sensed, the non-polarizing portion is inspected, the elongated polarizing plate is cut after positioning is performed with the sensed position of the non-polarizing portion as a reference in a case where the elongated polarizing plate is cut, and one sheet polarizing plate having one non-polarizing portion is obtained.

That is, in the manufacturing method, the non-polarizing portion is provided as a reference mark on the base material on which a plurality of polarizing plates are formed, and the cutout position of the polarizing plate is determined using the non-polarizing portion.

### SUMMARY OF THE INVENTION

As the reference mark, coloring with a writing tool such as a marker, coloring with printing, punching, blanking with an engraving blade, and hole opening using a plotter, a water jet, or the like are known.

Further, in JP6695670B, a reference mark is formed by non-polarization decomposition by chemical decomposition. As a method of forming the reference mark according to such a difference in optical characteristics, a method using laser ablation is also known.

That is, in the manufacturing of the optical sheet in which the cutting out from the base material in the related art is performed, a step of forming the reference mark is essential, and thus a device for forming the reference mark is necessary. Further, in order to accurately cut out the optical sheet, it is necessary to form the reference mark on a sheet as the base material with a high position accuracy, which takes time.

Therefore, in the optical sheet manufacturing method in the related art, a high cost is necessary to form the reference mark. In addition, it is necessary to increase the position accuracy of the optical sheet with respect to the reference mark, and thus the cost and effort are also necessary in this respect.

Further, the reference mark may be provided in a portion other than a formation portion of the optical sheet in consideration of product quality. In such a case, in addition to an area for forming the optical sheet, an area for forming the reference mark is necessary in the base material.

As a result, the number of products per unit area of the base material is reduced.

In addition, in the manufacturing method in the related art in which the optical sheet is cut out from the base material, the reference mark in the base material is detected and the optical sheet from the base material is cut out by different devices.

That is, in order to determine the cutout position of the optical sheet in the base material, usually, two or more reference marks are formed on one optical sheet.

Therefore, in order to detect the position of the reference mark with high accuracy, two sensors are necessary to detect the reference mark. Further, in order to detect the position of the reference mark with high accuracy, a positional relationship between the two sensors is also important.

Here, the optical sheet from the base material is cut out by, for example, punching using a cutting die. The cutting out of the optical sheet from such a base material is accompanied by an impact. Therefore, in a case where the punching and the detection of the reference mark are performed by the same device, there is a possibility that an error occurs in a positional relationship between the two sensors due to the impact.

In consideration of this point, in the manufacturing method of cutting out the optical sheet from the base material in the related art, the reference mark in the base material is detected and the optical sheet from the base material is cut out by different devices.

Therefore, the apparatus cost increases, and the manufacturing of the optical sheet also takes time. Further, the fact that the detection of the reference mark, that is, the determination of the cutout position of the optical sheet in the base material and the cutting out of the optical sheet from the base material are performed by different devices also causes an error in the cutout position of the optical sheet.

That is, in the related art, a manufacturing method of cutting out individual optical sheets from the base material, on which the plurality of optical sheets are formed, has high initial costs and running costs and takes time to manufacture the optical sheets.

In order to solve such a problem of the related art, an object of the present invention is to provide an optical sheet manufacturing method capable of cutting out an optical sheet from an optical sheet base material, with a low cost, simplicity, and higher accuracy, in the optical sheet manufacturing of cutting out the optical sheet from a base material, on which an optical sheet having a concentric circular pattern is formed, and to provide an optical sheet manufacturing apparatus that performs the optical sheet manufacturing method.

In order to achieve the above-mentioned object, the present invention has the following configurations.
[1] An optical sheet manufacturing method according to an aspect of the present invention comprises: detecting a center of a concentric circular pattern of the optical sheet in a case of cutting out the optical sheet from an optical sheet base material on which the optical sheet having the concentric circular pattern is formed; and determining a cutout position of the optical sheet in the optical sheet base material, in accordance with a detection result of the center of the concentric circular pattern.
[2] The optical sheet manufacturing method according to [1] further comprises detecting the center of the concentric circular pattern of the optical sheet using light reflected from the optical sheet base material.
[3] In the optical sheet manufacturing method according to [1] or [2], the center of the concentric circular pattern of the optical sheet is detected using an image obtained by performing irradiation with linearly polarized light.
[4] In the optical sheet manufacturing method according to any one of [1] to [3], the optical sheet is cut out by a cutting die having a through-hole at a center thereof, the center of the concentric circular pattern of the optical sheet is detected from a side opposite to a cutting edge of the cutting die through the through-hole of the cutting die, and the cutout position of the optical sheet in the optical sheet base material by the cutting die is determined by performing alignment for making the center of the concentric circular pattern of the detected optical sheet coincide with the center of the cutting die.
[5] In the optical sheet manufacturing method according to [4], the through-hole has a tapered shape of which a diameter gradually reduces toward the optical sheet base material.
[6] In the optical sheet manufacturing method according to [4] or [5], the center of the concentric circular pattern of the optical sheet is detected through image analysis of an image captured by an imaging device.
[7] In the optical sheet manufacturing method according to [6], an optical axis of the imaging device coincides with a center of the through-hole.
[8] In the optical sheet manufacturing method according to any one of [1] to [7], the concentric circular pattern of the optical sheet is a concentric circular liquid crystal alignment pattern.
[9] In the optical sheet manufacturing method according to any one of [1] to [8], after the center of the concentric circular pattern of the optical sheet is detected, the optical sheet base material is aligned with a cutting unit, which cuts out the optical sheet from the optical sheet base material, at a location thereof, and then the optical sheet is cut out from the optical sheet base material by the cutting unit.
[10] An optical sheet manufacturing apparatus according to an aspect of the present invention cuts out an optical sheet having a concentric circular pattern from an optical sheet base material on which the optical sheet is formed. The optical sheet manufacturing apparatus comprises: a table on which the optical sheet base material is placed; a cutting die that cuts out the optical sheet from the optical sheet base material and that has a through-hole at a center thereof; an imaging device that captures an image of the optical sheet base material placed on the table through the through-hole of the cutting die; an analyzing unit that detects a center of the concentric circular pattern of the optical sheet by performing image analysis on the image captured by the imaging device; and an adjusting unit that adjusts a positional relationship between the table and the cutting die such that a center of the cutting die coincides with the center of the concentric circular pattern of the optical sheet, in accordance with a detection result of the center of the concentric circular pattern of the optical sheet by the analyzing unit.

According to the aspects of the present invention, it is possible to cut out the optical sheet having the concentric circular pattern from the optical sheet base material, on which the optical sheet is formed, with a low cost, simplicity, and high accuracy.

### BRIEF DESCRIPTION OF THE DRAWINGS

FIG. 1 is a diagram conceptually showing an example of an optical sheet manufacturing apparatus according to the present invention, the optical sheet manufacturing apparatus performing an example of an optical sheet manufacturing method according to the present invention.

FIG. 2 is a schematic cross-sectional view of an example of a cutting die used in the present invention.

FIG. 3 is a diagram conceptually showing a configuration of an example of the imaging device used in the present invention.

FIG. 4 is a diagram conceptually showing an example of a liquid crystal lens.

FIG. 5 is a diagram showing image processing of a photograph of a liquid crystal lens.

### DESCRIPTION OF THE PREFERRED EMBODIMENTS

Hereinafter, an optical sheet manufacturing method and an optical sheet manufacturing apparatus according to embodiments of the present invention will be described in detail on the basis of preferable embodiments shown in the accompanying drawings.

The drawings to be described later are exemplary drawings for describing the embodiments of the present invention, and the present invention is not limited to the drawings to be described later.

Further, the drawings to be described later are conceptual views for describing the embodiments of the present invention, and the sizes, shapes, positional relationships, and the like of the members are different from the actual ones.

In the following description, “to” indicating a numerical range includes numerical values described on both sides thereof. For example, in a case where ε is a numerical value α to a numerical value β, the range ε is a range including the numerical value α and the numerical value β, which is expressed by a mathematical symbol α≤ε≤β.

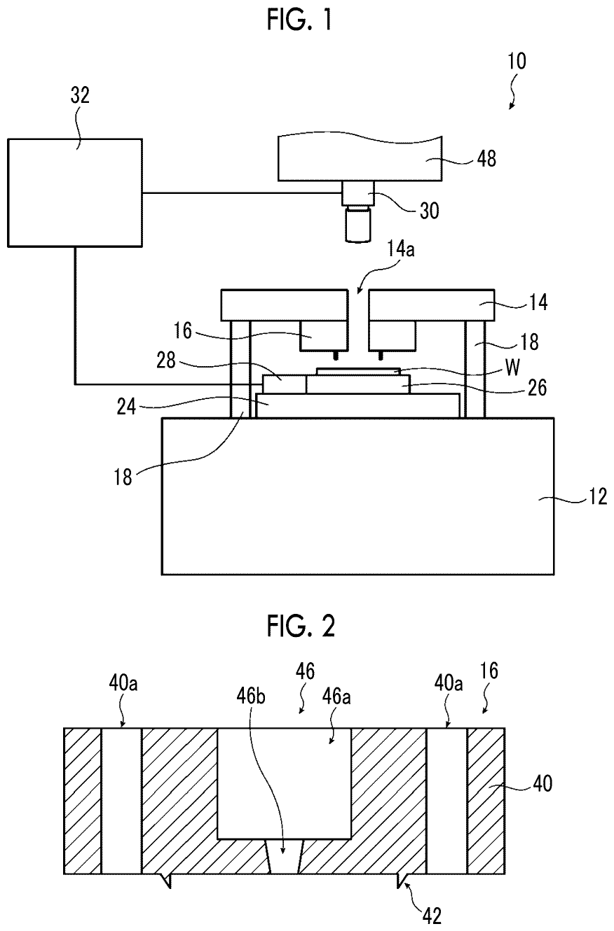

FIG. 1 conceptually shows an example of the optical sheet manufacturing apparatus according to the embodiment of the present invention, the optical sheet manufacturing apparatus performing an example of the optical sheet manufacturing method according to the embodiment of the present invention.

The optical sheet manufacturing apparatus according to the embodiment of the present invention cuts out each optical sheet from an optical sheet base material W on which an optical sheet having a concentric circular pattern is formed. The number of optical sheets formed on the optical sheet base material W may be one or more. In the following description, the “optical sheet base material W” is also simply referred to as a “base material W”.

An optical sheet manufacturing apparatus 10 in an example shown in the drawing includes a base 12, a cutting die support base 14, a cutting die 16, a table support base 24, a placement table 26, a moving mechanism 28, an imaging device 30, and an image analyzing device 32. In the following description, the “optical sheet manufacturing apparatus” is also simply referred to as a “manufacturing apparatus”.

The base 12 supports the cutting die support base 14 and the table support base 24. The cutting die support base 14 is supported by four posts 18.

An elevation mechanism that elevates and lowers the cutting die support base 14, that is, the posts 18 are built in the base 12.

The cutting die support base 14 is a rectangular plate body that supports the cutting die 16.

The cutting die 16 is a cutting die that cuts out the optical sheet from the base material W by punching out the optical sheet from the base material W, and a known cutting die can be used.

In the example shown in the drawing, the cutting die 16 punches out the optical sheet in a rectangular shape from the base material W as an example. In the embodiment of the present invention, the rectangle includes a square. It should be noted that, in the embodiment of the present invention, a cutout shape of the optical sheet from the base material W is not limited to a rectangular shape. Consequently, in the embodiment of the present invention, the cutout shape of the optical sheet from the base material W is not limited, for example, the optical sheet is punched out from the base material W in a circular shape.

FIG. 2 conceptually shows a cross-sectional view of the cutting die 16.

As shown in FIG. 2, the cutting die 16 includes a body 40 and a cutting edge 42 that punches out the optical sheet from the base material W.

In the example shown in the drawing, the cutting die 16 is a so-called engraving blade that is manufactured by integrally removing the body 40 and the cutting edge 42.

In the embodiment of the present invention, the cutting die is not limited thereto. It is possible to use various kinds of known cutting dies such as a cutting die, in which a cutting edge is embedded and fixed with plywood as a body, and a cutting die, in which a cutting edge is embedded and fixed with a body made of metal such as stainless steel. However, the cutting die, in which the cutting edge is embedded in the body made of metal and fixed, is preferable in consideration of suppression of dimensional change due to moisture absorption, durability, dimensional accuracy, position accuracy of a cutting edge, a through-hole, and the like, and solidity against a shear stress applied to the blade of the cutting die. Among the cutting dies, the engraving blade as shown in the example of the drawing is more preferable.

The body 40 is provided with a mounting hole 40a. The cutting die 16 is attached to a predetermined position of the cutting die support base 14 by using the mounting hole 40a, for example, by a bolt.

The method of attaching the cutting die 16 to the cutting die support base 14 is not limited to the method, and various known attachment methods can be used.

In a preferable aspect, the cutting die 16 has a through-hole 46 at a center of the cutting edge 42. The through-hole 46 is a cylindrical through-hole, and has a large diameter portion 46a and a small diameter portion 46b on the cutting edge 42 side. The large diameter portion 46a and the small diameter portion 46b have cylindrical shapes having centers that coincide with each other.

Further, as a preferred aspect, the small diameter portion 46b has a tapered shape of which a diameter gradually reduces toward the cutting edge 42 side.

Furthermore, in a preferable aspect, in the cutting die 16, the center of the cutting edge 42 coincides with the center of the through-hole 46.

The center of the cutting edge 42 is usually the center of the cutting die 16. In a case where the center of the cutting edge 42 does not coincide with the center of the cutting die 16, the through-hole 46 is formed at the center of the cutting edge 42.

Further, the cutting die support base 14 also has a cylindrical through-hole 14a having the same diameter as the large diameter portion 46a, which communicates with the large diameter portion 46a of the through-hole 46 of the cutting die 16.

As will be described later, the imaging device 30 captures an image of an optical sheet having a concentric circular pattern which is formed on the base material W through the through-hole 46. Further, in the manufacturing apparatus 10, the center of the concentric circular pattern of the optical sheet is detected by performing image analysis on the captured image.

In the following description, the “concentric circular pattern” will also be simply referred to as a “concentric circle”.

Here, as in the example shown in the drawing, by making the small diameter portion 46b of the through-hole 46 tapered so as to gradually reduce the diameter toward the cutting edge 42 side, an imaging range of the imaging device 30, that is, an observation range for detecting the center of the concentric circle can be narrowed down. Further, by narrowing down the imaging range, it is possible to detect a positional relationship between the center of the concentric circle of the optical sheet and the center of the through-hole 46 (small diameter portion 46b), that is, the center of the cutting edge 42 at a position closer to the optical sheet. As a result, the detection of the center of the concentric circle of the optical sheet can be performed with higher accuracy.

A degree of reduction in diameter of the taper in the small diameter portion 46b, that is, a degree of reduction in diameter of the through-hole 46 is not limited. The degree may be appropriately set in accordance with an area of the punched portion by the cutting edge 42, a size of the through-hole 46, an interval between dark lines in the central portion of the concentric circle of the optical sheet, and the like.

Here, in order to detect the center of the concentric circle of the optical sheet, it is necessary for an opening on the cutting edge 42 side of the small diameter portion 46b to have a certain area. On the other hand, in a case where the area of the opening of the small diameter portion 46b on the cutting edge 42 side is excessively large, the solidity of the cutting die 16 is reduced.

In consideration of this point, an area of the opening on the cutting edge 42 side of the small diameter portion 46b of the through-hole 46 is preferably 0.05% to 10% and more preferably 0.5% to 2.5% of the punched area by the cutting edge 42.

As described above, the cutting die support base 14 is a rectangular plate body that supports the cutting die 16.

The cutting die support base 14 is supported by the base 12 by four posts 18 provided in the vicinities of the corner portions. As described above, the base 12 has an elevation mechanism of the posts 18 built therein.

That is, in the manufacturing apparatus 10, the posts 18 are lowered to lower the cutting die support base 14, that is, the cutting die 16, and the optical sheet is cut out from the base material W by the cutting edge 42.

In the embodiment of the present invention, the elevation mechanism of the posts 18 is not limited. It is possible to use various known elevation mechanisms, such as an elevation mechanism using oil pressure, a mechanical elevation mechanism, and an elevation mechanism driven by a motor, oil pressure, or the like in combination with a rod-type sliding guide, a rail-type sliding guide, a mechanical toggle mechanism, or the like.

The table support base 24 is fixed on the upper surface of the base 12, and the placement table 26 is supported by the table support base 24. Further, the moving mechanism 28 is provided on the table support base 24.

The table support base 24 is a base that movably supports the placement table 26.

The placement table 26 is a table on which the base material W from which the optical sheet is cut out is placed, and is formed of, for example, a metal plate such as stainless steel.

The placement table 26 is movably supported by the table support base 24 at a position corresponding to the through-hole 46 of the cutting die 16.

In a preferable aspect, the placement table 26 has a fixing unit for fixing the base material W to prevent the base material W from being moved unnecessarily and to suppress deformation such as curling and expansion and contraction of the base material W.

A method of fixing the base material W to the placement table 26 is not limited. A known method such as a method using adsorption (suction), a method using magnetism, or a method using a jig can be used. Among the methods, the fixing of the base material W by adsorption is suitably exemplified.

The moving mechanism 28 for adjusting a position of the placement table 26 is provided on the table support base 24.

The moving mechanism 28 adjusts the position of the placement table 26 by moving the placement table 26 in an x direction and a y direction orthogonal to each other.

Although described in detail later, in the manufacturing apparatus 10, the center of the concentric circle of the optical sheet formed on the base material W is detected from the captured image of the base material W by the imaging device 30 to be described later. Thereafter, the position of the placement table 26 is adjusted by the moving mechanism 28 to make the center of the concentric circle of the optical sheet coincide with the center of the cutting die 16, that is, the center of the cutting edge 42, and then the cutting die 16 cuts out the optical sheet from the base material W.

The moving mechanism 28 is not limited. It is possible to use various well-known mechanisms used for an x-y stage or the like, such as a ball screw feeding mechanism in combination with a rod-type sliding guide and/or a rail-type sliding guide.

Further, the movement of the placement table 26 performed by the moving mechanism 28 may be performed manually or automatically. In the manufacturing apparatus 10 in the example shown in the drawing, in a preferable aspect, the moving mechanism 28 automatically moves the placement table 26 in response to an instruction issued from the image analyzing device 32 to align the center of the concentric circle of the optical sheet with the center of the cutting die 16, that is, the center of the cutting edge 42.

The imaging device 30 is provided above the cutting die support base 14 in the drawing.

The imaging device 30 is supported by an imaging device support portion 48. The imaging device support portion 48 is preferably not connected to the base 12 and is independently supported. By supporting the imaging device support portion 48 independently of the base 12, it is possible to suppress mechanical distortion in fixation of the imaging device 30 caused by the propagation of an impact during cutting out, adverse effects on electronic equipment such as the CCD sensor, and the like.

The imaging device 30 is an imaging device that uses a known imaging element such as a CCD sensor.

In the manufacturing apparatus 10, the imaging device 30 captures the image of the base material W supported on the placement table 26 from the side opposite to the cutting edge 42 through the through-hole 14a of the cutting die support base 14 and the through-hole 46 of the cutting die 16.

In a preferable aspect, in the imaging device 30, the optical axis thereof coincides with the center of the cutting die 16, that is, the center of the cutting edge 42. As described above, in a preferable aspect, the center of the through-hole 46 of the cutting die 16 coincides with the center of the cutting die 16, that is, the center of the cutting edge 42.

That is, in the manufacturing apparatus 10, in a more preferable aspect, the optical axis thereof coincides with the center of the cutting die 16, the center of the through-hole 46 of the cutting die 16, and the center of the imaging device 30. Therefore, in the alignment to be described later, the center of the cutting die 16 can be made to coincide with the center of the concentric circle of the optical sheet by making the optical axis of the image, which is captured by the imaging device 30, coincide with the center of the concentric circle of the detected optical sheet.

It should be noted that, in the embodiment of the present invention, the imaging of the optical sheet is not limited to being performed through the through-hole 46 of the cutting die 16. For example, the imaging device may be provided on the lower surface of the cutting die support base 14, and the imaging device may capture the image of the optical sheet.

However, in the embodiment of the present invention, as in the example shown in the drawing, it is preferable that the through-hole 46 is provided at the center of the cutting die 16 and the image of the optical sheet is captured through the through-hole 46. Thereby, the imaging of the optical sheet can be performed from directly above, that is, from a normal direction, by making the center of the concentric circle substantially coincide with the optical axis, and the center of the concentric circle can be more accurately detected through the image analysis. The normal direction is a direction orthogonal to a surface direction of a sheet-like material (a plate-like material, a layer, or a film).

In the embodiment of the present invention, the light for detecting the center of the concentric circle of the optical sheet formed on the base material W is not limited. Various kinds of the light can be used. Further, the light for detecting the center of the concentric circle of the optical sheet formed on the base material W may be polarized light or unpolarized light. Here, in the embodiment of the present invention, it is preferable that the center of the concentric circle of the optical sheet formed on the base material W is detected by performing irradiation with linearly polarized light.

In the manufacturing apparatus 10, in a preferable aspect, the imaging device 30 irradiates the base material W with linearly polarized light to capture an image of the base material W. That is, in a preferable aspect, the manufacturing apparatus 10 captures the image of the base material W by using linearly polarized light as imaging light.

Thereby, the concentric circle of the optical sheet, specifically, the concentric circle of the optical sheet due to the bright and dark lines in the image of the base material W captured by the imaging device 30 can be made clearer. As a result, higher detection accuracy of the center of the concentric circle of the optical sheet can be achieved.

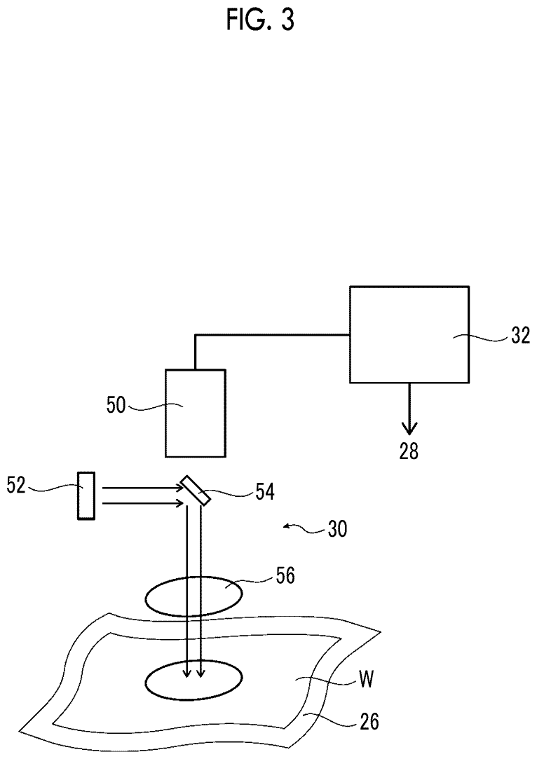

FIG. 3 conceptually shows a configuration of the imaging device 30.

As shown in FIG. 3, the imaging device 30 includes an imaging element 50, such as a CCD sensor, a light source 52, a half mirror 54, and a linearly polarizing plate 56.

The light source 52 emits white light. The light emitted from the light source 52 is reflected toward the base material W by the half mirror 54, and is transmitted through the linearly polarizing plate 56. The base material W is irradiated with the light as linearly polarized light.

The imaging element 50 captures an image of the base material W through the half mirror 54 by using the linearly polarized light with which the base material W is irradiated as the imaging light. That is, in the example shown in the drawing, in a preferable aspect in which the movement of the base material W and the detachment of the placement table 26 are not necessary, the imaging element 50 captures an image of the reflected light which is reflected by the base material W. However, the present invention is not limited thereto, and an image of the transmitted light of the base material W may be captured.

The polarization direction of the linearly polarized light to be applied to the base material W is not limited. Therefore, the linearly polarized light to be applied to the base material W may be S-polarized light or P-polarized light.

The image analyzing device 32 detects a center of a concentric circle of one optical sheet of the optical sheets each having a concentric circular pattern formed on the base material W from the image of the base material W captured by the imaging device 30. Further, the image analyzing device 32 gives an instruction to move the placement table 26 in accordance with the detection result of the center of the concentric circle.

Such an image analyzing device 32 may be configured by using a general-purpose computer and general-purpose software. Furthermore, the image analyzing device 32 may have a display for displaying an image or the like captured by the imaging device 30, as necessary.

The image analyzing device 32 will be described in detail later.

As described above, in the embodiment of the present invention, the optical sheet is cut out from one or a plurality of base materials W (optical sheet base material W) on which the optical sheet having the concentric circular pattern is formed.

Examples of the optical sheet having the concentric circular pattern (optical pattern) include a liquid crystal lens (liquid crystal diffractive lens).

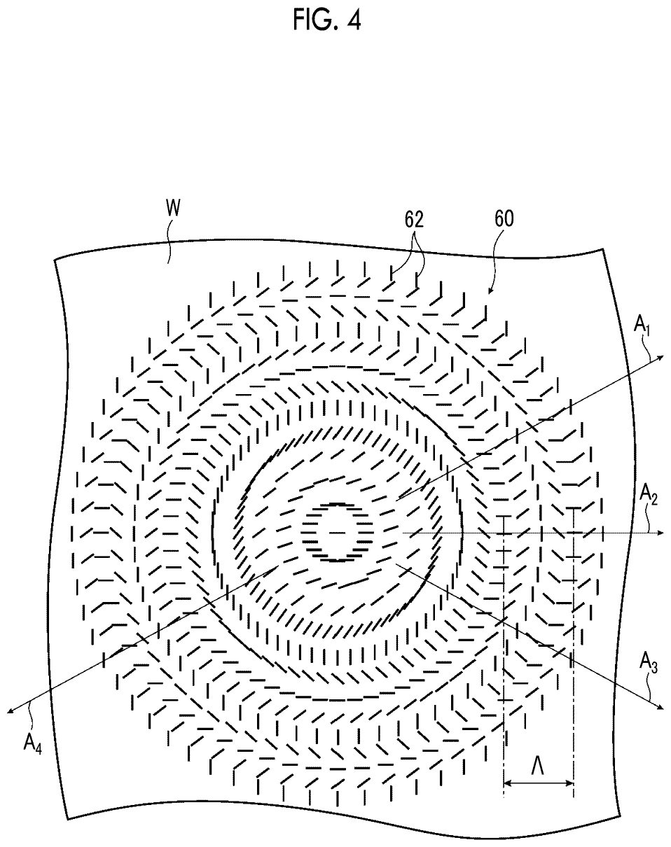

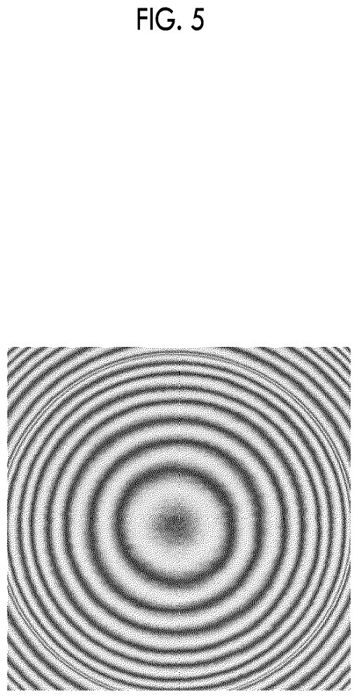

FIG. 4 conceptually shows an example of the liquid crystal lens.

For example, the liquid crystal lens 60 shown in FIG. 4 has a substrate, an alignment film formed on one surface of the substrate, and a liquid crystal layer (optically anisotropic layer) formed on a surface of the alignment film. FIG. 4 shows the surface of the liquid crystal layer.

The liquid crystal lens 60 (liquid crystal layer) has a liquid crystal alignment pattern in which orientations of the optical axes derived from liquid crystal compounds 62 change while continuously rotating toward one direction and which has a radial shape from the inside to the outside.

That is, as shown in FIG. 4, the liquid crystal alignment pattern of the liquid crystal lens 60 is a concentric circular liquid crystal alignment pattern having a concentric circular shape. In the concentric circular shape, one direction, in which the orientations of the optical axes derived from the liquid crystal compounds 62 change while continuously rotating, is concentrically circular from the inside toward the outside. In other words, the concentric circular pattern in the liquid crystal lens 60 is a concentric circular liquid crystal alignment pattern having a concentric circular shape. In the concentric circular shape, the liquid crystal alignment pattern, in which the orientations of the optical axes derived from the liquid crystal compounds 62 change while continuously rotating along one direction in the plane, is concentrically circular from the inside toward the outside.

It should be noted that in the liquid crystal lens 60, the liquid crystal compounds 62 are fixed.

The optical axis, which is derived from the liquid crystal compound 62, is an axis having the highest refractive index in the liquid crystal compound 62, that is, a so-called slow axis.

In FIG. 4, a rod-like liquid crystal compound is exemplified as the liquid crystal compound 62. Accordingly, the orientation of the optical axis derived from the liquid crystal compound 62 is along a major axis direction of a rod shape of the liquid crystal compound 62.

In the liquid crystal lens 60, the orientations of the optical axes of the liquid crystal compounds 62 change while continuously rotating in a plurality of directions from the center of the liquid crystal lens 60 toward the outside. For example, the directions include a direction indicated by an arrow A₁, a direction indicated by an arrow A₂, a direction indicated by an arrow A₃, a direction indicated by an arrow A₄, and . . . .

Accordingly, in the liquid crystal lens 60, a rotation direction of the optical axes of the liquid crystal compounds 62 is the same in all directions (one direction). In the example shown in the drawing, the rotation direction of the optical axis of the liquid crystal compound 62 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are regarded as one straight line, the rotation direction of the optical axes of the liquid crystal compounds 62 is reversed at the center of the liquid crystal lens 60 on the straight line. For example, the straight line formed by the arrow A₁ and the arrow A₄ is directed in the right direction (arrow A₁ direction) in the drawing. In such a case, the optical axes of the liquid crystal compounds 62 initially rotate clockwise from the outer direction toward the center of the liquid crystal lens 60 and are reversed at the center of the liquid crystal lens 60, and then rotate counterclockwise from the center of the liquid crystal lens 60 toward the outer direction.

In the liquid crystal alignment pattern, a length, within which the orientation of the optical axis derived from the liquid crystal compound rotates by 180° in one direction in which the orientations of the optical axes of the liquid crystal compounds 62 change while continuously rotating, is set as a single period Λ. In the liquid crystal lens 60, as the period Λ decreases, a refractive index (diffraction angle) of the lens increases.

Further, in the liquid crystal lens 60, the length of the single period Λ decreases from the inside toward the outside. Thereby, the liquid crystal lens 60 concentrates incidence light.

The liquid crystal lens 60 exhibits refraction (diffraction) mainly with respect to circularly polarized light, and the refraction direction varies depending on the rotation direction of the optical axes of the liquid crystal compounds 62 toward one direction and the revolution direction of the circularly polarized light.

That is, the liquid crystal lens 60 concentrates right circularly polarized light and diffuses left circularly polarized light. Alternatively, the liquid crystal lens 60 diffuses the right circularly polarized light and concentrates the left circularly polarized light.

As shown in FIG. 4, in the concentric circular liquid crystal alignment pattern of the liquid crystal lens 60, in each circle constituting the concentric circle, the liquid crystal compounds 62 (optical axes) existing on the same circle have the same orientation, that is, the same alignment direction.

In a case where the liquid crystal lens 60 is imaged by an imaging device using a CCD sensor or the like, concentric circular bright and dark lines are observed depending on the alignment direction of the liquid crystal compounds 62. Preferably, as described above, in a case where the liquid crystal lens 60 is irradiated with linearly polarized light and an image thereof is captured, concentrically circular dark and bright lines are clear.

FIG. 5 shows an example of an image captured by imaging the liquid crystal lens 60.

It should be noted that, in the imaging, STC-MBS500U3V (manufactured by Omron Sentech Co., Ltd.) is used as an imaging element, VS-TCH1-110CO (manufactured by VS Technology Inc.) is used as a telecentric lens, PL-27-NL (manufactured by CCS Inc.) is used as a linearly polarizing plate, OPS-S20W (manufactured by Optex FA Co., Ltd.) is used as a light source, and SV-G533-270 (manufactured by VS Technology Inc.) is used as a bandpass filter. The imaging is performed using the imaging device 30 shown in FIG. 3.

It should be noted that, in the embodiment of the present invention, the concentric circular optical sheet is not limited to the liquid crystal lens.

That is, the embodiment of the present invention can be used for manufacturing various well-known optical sheets (sheet-like optical elements) such as a Fresnel lens in addition to the liquid crystal lens.

Hereinafter, the action of the manufacturing apparatus 10 will be described in detail. Thus, the optical sheet manufacturing method and the optical sheet manufacturing apparatus according to the embodiment of the present invention will be described in more detail.

First, the base material W (optical sheet base material W), on which the optical sheet is formed, is placed on the placement table 26 such that the center of the concentric circular pattern of one optical sheet coincides with the center of the cutting die 16 (cutting edge 42). Then, preferably, the base material W is fixed to the placement table 26 by the method such as adsorption.

Next, in the imaging device 30, the light source 52 is turned on to irradiate the optical sheet with linearly polarized light. Further, the imaging device 30 captures an image of the optical sheet. As described above, the imaging is performed through the through-hole 14a of the cutting die support base 14 and the through-hole 46 provided at the center of the cutting die 16.

Thereby, as described above, an image of concentric circular bright and dark lines as shown in FIG. 5 is captured in accordance with the concentric circular pattern of the optical sheet.

An image (image data) of the concentric circular pattern of the optical sheet captured by the imaging device 30 is transmitted to the image analyzing device 32.

The image analyzing device 32 detects the center of the concentric circular shape of the optical sheet by performing image analysis on the image of the concentric circular pattern of the supplied optical sheet. The center of the concentric circle is the center of the concentric circular pattern of the optical sheet as described above.

The center of the concentric circle from the image captured by imaging the concentric circular pattern in the image analyzing device 32 can be detected by using general-purpose image processing software. For example, image processing software having a pattern matching function and performing image analysis of recognizing a circle and finding a center of the circle may be used. Examples of such image processing software include CV-X series, XG-X series, and the like manufactured by KEYENCE Corporation. In particular, the XG-X series is suitably exemplified.

Then, the image analyzing device 32 calculates a movement direction and a movement amount of the placement table 26 in order to make the center of the concentric circle of the optical sheet coincide with the center of the cutting die 16 (cutting edge 42).

As described above, in the manufacturing apparatus 10, the through-hole 46 is provided at the center of the cutting die 16, and the imaging device 30 captures an image of the concentric circular pattern of the optical sheet through the through-hole 46. A positional relationship between the center of the cutting die 16 and the center of the through-hole 46 is naturally known, and the image analyzing device 32 recognizes the information.

The image analyzing device 32 calculates a movement direction and a movement amount (movement distance) of the placement table 26 for making the center of the cutting die 16 coincide with the center of the concentric circle of the optical sheet by using the positional relationship between the center of the cutting die 16 and the center of the through-hole 46.

Here, in the manufacturing apparatus 10 in the example shown in the drawing, in a preferable aspect, the center of the cutting die 16 coincides with the center of the through-hole 46. Therefore, the image analyzing device 32 may calculate the movement direction and the movement amount of the placement table 26 such that the center of the through-hole 46 coincides with the center of the concentric circle of the detected optical sheet. Therefore, with such a configuration, it is possible to more simply and accurately calculate the movement direction and the movement amount of the placement table 26 for making the center of the cutting die 16 coincide with the center of the concentric circle of the optical sheet.

In addition, in the manufacturing apparatus 10 of the example shown in the drawing, in a more preferable aspect, the optical axis of the imaging device 30 coincides with the center of the through-hole 46. Therefore, the image analyzing device 32 need only calculate the movement direction and the movement amount of the placement table 26 such that the optical axis of the imaging device, that is, the center of the image in general coincides with the center of the concentric circle of the detected optical sheet. Therefore, with such a configuration, it is possible to further simplify and increase the accuracy of the calculation of the movement direction and the movement amount of the placement table 26 for making the center of the cutting die 16 coincide with the center of the concentric circle of the optical sheet.

In a case where the image analyzing device 32 calculates the movement direction and the movement amount of the placement table 26 such that the center of the concentric circular pattern of the optical sheet coincides with the center of the cutting die 16, that is, the center of the cutting edge 42, the image analyzing device 32 issues an instruction to the moving mechanism 28 such that the moving mechanism 28 moves the placement table 26 in accordance with the calculated movement direction and movement amount.

In response to the instruction, the moving mechanism 28 moves the placement table 26 in either the X direction or the Y direction to make the center of the concentric circular pattern of the optical sheet coincide with the center of the cutting die 16. Thereby, the cutting die 16 determines the cutout position of the optical sheet in the base material W.

It should be noted that, in the embodiment of the present invention, the alignment for making the center of the concentric circular pattern of the optical sheet coincides with the center of the cutting die 16, that is, the center of the cutting edge 42 is not limited to being automatically performed by the moving mechanism 28 as described above, and may be manually performed.

For example, in a case where the image analyzing device 32 detects the center of the concentric circle of the optical sheet, the image (motion picture) captured by the imaging device 30 and the position of the center of the concentric circle of the detected optical sheet are displayed on a display of the image analyzing device 32. Preferably, the center position of the cutting die 16 is also displayed on the display. Next, the operator manually operates the moving mechanism 28 while observing the image to move the placement table 26, thereby making the center of the concentric circle of the optical sheet coincide with the center of the cutting die 16.

In a case where the center of the concentric circle of the optical sheet coincides with the center of the cutting die 16, the elevation mechanism provided in the base 12 is driven to lower the cutting die support base 14, that is, the cutting die 16, and the optical sheet is cut out from the base material W.

It is apparent from the above description that, in the embodiment of the present invention, in a case where each optical sheet is cut out from the base material W on which the optical sheet having the concentric circular pattern is formed, the center of the concentric circular shape of the optical sheet is used as a reference mark.

Therefore, according to the embodiment of the present invention, it is possible to eliminate the necessity for a forming step and a forming device for the reference mark, which are essential in the manufacturing method in the related art and for which high accuracy is necessary.

Further, since the reference mark is not necessary, a space for the reference mark in the base material W is also not necessary. Therefore, according to the embodiment of the present invention, the number of optical sheets formed on the unit area of the base material W can be increased, and the number of optical sheets, that is, the number of products that can be taken from one base material W can be increased.

Further, as described above, in the optical sheet manufacturing method using the reference mark in the related art, two or more reference marks are necessary for one optical sheet. Therefore, in the manufacturing method of the related art, the reference mark is detected by using sensors corresponding to the number of reference marks formed on one optical sheet. As a result, in the manufacturing method of the related art, it is necessary to perform the detection of the reference mark and the cutting out of the optical sheet from the base material by different devices, which takes time for cutting out the optical sheet from the base material and causes an error.

On the other hand, in the embodiment of the present invention, the center of the concentric circle of the optical sheet is detected. Therefore, it is possible to make the detection of the reference mark by the plurality of detection units unnecessary. Therefore, according to the embodiment of the present invention, the detection of the center of the optical sheet having a concentric circular shape and the cutting out of the optical sheet from the base material can be continuously performed by one device. As a result, the workability can be improved, and the cutout accuracy of the optical sheet can be improved.

Moreover, in the manufacturing apparatus 10 of the example shown in the drawing, in a preferable aspect, the through-hole 46 is provided at the center of the cutting die 16, and the imaging device 30 captures the image of the optical sheet through the through-hole 46 from the side opposite to the cutting edge 42. Preferably, the center of the cutting die 16 coincides with the center of the through-hole, and more preferably, the optical axis of the imaging device 30 further coincides with the center of the through-hole 46.

That is, in the manufacturing apparatus 10 of the example shown in the drawing, the image of the concentric circular pattern of the optical sheet is directly captured (observed) from directly above, the center of the concentric circle of the optical sheet that is a reference mark is detected, and the alignment between the optical sheet and the cutting die 16 can be performed.

As a result, the manufacturing apparatus 10 is able to cut out the optical sheet from the base material W more easily and quickly and with higher accuracy.

In addition, in a more preferable aspect, the through-hole 46 provided in the cutting die 16 is tapered to gradually reduce in diameter toward the cutting edge 42. Thereby, the imaging region of the imaging device 30 can be narrowed down, and the imaging can be performed in a state where the cutting die 16 and the optical sheet (base material W) are close to each other. Therefore, with such a configuration, it is possible to detect the center of the concentric circular pattern with higher accuracy and simplicity.

As described above, according to the embodiment of the present invention, in the optical sheet manufacturing in which individual optical sheets are cut out from the base material on which the optical sheets are formed, the cutout accuracy of the optical sheet can be improved, and the initial cost and the running cost can be reduced. In addition, the optical sheet can be easily manufactured.

Hereinabove, the optical sheet manufacturing method and the optical sheet manufacturing apparatus according to the embodiment of the present invention have been described in detail. However, the present invention is not limited to the above-described examples, and various improvements or modifications can be made without departing from the scope of the present invention.

The method is suitably used for manufacturing an optical sheet such as a liquid crystal lens.

### EXPLANATION OF REFERENCES

10: manufacturing apparatus
12: base
14: cutting die support base
16: cutting die
18: post
24: table support base
26: placement table
28: moving mechanism
30: imaging device
32: image analyzing device
40: body
40a: mounting hole
42: cutting edge
46: through-hole
46a: large diameter portion
46b: small diameter portion
48: imaging device support portion
50: imaging element
52: light source
54: half mirror
56: linearly polarizing plate
60: liquid crystal lens
62: liquid crystal compound
W (optical sheet): base material

What is claimed is:

1. An optical sheet manufacturing method comprising:
detecting a center of a concentric circular pattern of an optical sheet in a case of cutting out the optical sheet from an optical sheet base material on which the optical sheet having the concentric circular pattern is formed; and
determining a cutout position of the optical sheet in the optical sheet base material, in accordance with a detection result of the center of the concentric circular pattern,
wherein the center of the concentric circular pattern of the optical sheet is detected using an image obtained by performing irradiation with linearly polarized light.

2. The optical sheet manufacturing method according to claim 1, further comprising:
detecting the center of the concentric circular pattern of the optical sheet using light reflected from the optical sheet base material.

3. The optical sheet manufacturing method according to claim 1,
wherein the optical sheet is cut out by a cutting die having a through-hole at a center thereof,
the center of the concentric circular pattern of the optical sheet is detected from a side opposite to a cutting edge of the cutting die through the through-hole of the cutting die, and
the cutout position of the optical sheet in the optical sheet base material by the cutting die is determined by performing alignment for making the center of the concentric circular pattern of the detected optical sheet coincide with the center of the cutting die.

4. The optical sheet manufacturing method according to claim 3,
wherein the through-hole has a tapered shape of which a diameter gradually reduces toward the optical sheet base material.

5. The optical sheet manufacturing method according to claim 3,
wherein the center of the concentric circular pattern of the optical sheet is detected through image analysis of an image captured by an imaging device.

6. The optical sheet manufacturing method according to claim 5,
wherein an optical axis of the imaging device coincides with a center of the through-hole.

7. The optical sheet manufacturing method according to claim 1,
wherein the concentric circular pattern of the optical sheet is a concentric circular liquid crystal alignment pattern.

8. The optical sheet manufacturing method according to claim 1,
wherein after the center of the concentric circular pattern of the optical sheet is detected, the optical sheet base material is aligned with a cutting unit, which cuts out the optical sheet from the optical sheet base material, at a location thereof, and then the optical sheet is cut out from the optical sheet base material by the cutting unit.

9. An optical sheet manufacturing apparatus that cuts out an optical sheet having a concentric circular pattern from an optical sheet base material on which the optical sheet is formed, the optical sheet manufacturing apparatus comprising:
a table on which the optical sheet base material is placed;
a cutting die that cuts out the optical sheet from the optical sheet base material and that has a through-hole at a center thereof;
an imaging device that captures an image of the optical sheet base material placed on the table through the through-hole of the cutting die;
an analyzing unit that detects a center of the concentric circular pattern of the optical sheet by performing image analysis on the image captured by the imaging device; and
an adjusting unit that adjusts a positional relationship between the table and the cutting die such that a center of the cutting die coincides with the center of the concentric circular pattern of the optical sheet, in accordance with a detection result of the center of the concentric circular pattern of the optical sheet by the analyzing unit.

10. The optical sheet manufacturing method according to claim 2,
wherein the optical sheet is cut out by a cutting die having a through-hole at a center thereof,
the center of the concentric circular pattern of the optical sheet is detected from a side opposite to a cutting edge of the cutting die through the through-hole of the cutting die, and
the cutout position of the optical sheet in the optical sheet base material by the cutting die is determined by performing alignment for making the center of the concentric circular pattern of the detected optical sheet coincide with the center of the cutting die.

11. The optical sheet manufacturing method according to claim 10,
wherein the through-hole has a tapered shape of which a diameter gradually reduces toward the optical sheet base material.

12. The optical sheet manufacturing method according to claim 10,
wherein the center of the concentric circular pattern of the optical sheet is detected through image analysis of an image captured by an imaging device.

13. The optical sheet manufacturing method according to claim 12,
wherein an optical axis of the imaging device coincides with a center of the through-hole.

14. The optical sheet manufacturing method according to claim 2,
wherein the concentric circular pattern of the optical sheet is a concentric circular liquid crystal alignment pattern.

15. The optical sheet manufacturing method according to claim 2,
wherein after the center of the concentric circular pattern of the optical sheet is detected, the optical sheet base material is aligned with a cutting unit, which cuts out the optical sheet from the optical sheet base material, at a location thereof, and then the optical sheet is cut out from the optical sheet base material by the cutting unit.

16. The optical sheet manufacturing method according to claim 4,
wherein the center of the concentric circular pattern of the optical sheet is detected through image analysis of an image captured by an imaging device.

17. The optical sheet manufacturing method according to claim 3,
wherein the concentric circular pattern of the optical sheet is a concentric circular liquid crystal alignment pattern.

18. The optical sheet manufacturing method according to claim 3,
wherein after the center of the concentric circular pattern of the optical sheet is detected, the optical sheet base material is aligned with a cutting unit, which cuts out the optical sheet from the optical sheet base material, at a location thereof, and then the optical sheet is cut out from the optical sheet base material by the cutting unit.

19. The optical sheet manufacturing method according to claim 4,
wherein the concentric circular pattern of the optical sheet is a concentric circular liquid crystal alignment pattern.

20. The optical sheet manufacturing method according to claim 4,
wherein after the center of the concentric circular pattern of the optical sheet is detected, the optical sheet base material is aligned with a cutting unit, which cuts out the optical sheet from the optical sheet base material, at a location thereof, and then the optical sheet is cut out from the optical sheet base material by the cutting unit.
